(19) United States
(12) Patent Application Publication
(10) Pub. No.: US 2005/0281496 A1
(43) Pub. Date: Dec. 22, 2005

(54) Linear motion device

(75) Inventors: Daiju Takahashi, Kanagawa (JP); Toshiharu Kajita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 11/089,015

(22) Filed: Mar. 25, 2005

(30) Foreign Application Priority Data
Apr. 11, 2003 (JP) P.2003-108230

(51) Int. Cl. F16C 33/10

(52) U.S. Cl. 384/13

(57) ABSTRACT

A linear motion device for receiving a load through a plurality of rolling elements sandwiched between a first and a second rolling-element rolling groove, wherein oil reservoirs constituted by numerous infinitesimal recesses each having a substantially circular arc-shaped section and having a surface roughness of 0.02 to 0.2 μm Ra are formed in the surface of at least one of each of the rolling elements, the first rolling-element rolling groove, and the second rolling-element rolling groove.

### BACKGROUND OF THE INVENTION

1. Field of the Invention

The present invention relates to a linear motion device, which includes, for example, a linear guide bearing device such as a linear guide device and a cross roller guide device, and a ball screw device, which are used in the field of industrial machinery and the like.

2. Description of the Related Art

As a linear guide bearing device, a linear guide device shown in FIG. 8 is known, for example.

This linear guide device has a guide rail 1 extending in the axial direction and a slider 2 which is mounted on the guide rail 1 in such a manner as to be relatively movable in the axial direction.

Two upper and lower rolling-element rolling grooves 3 on one side are formed on either transverse side surface of the guide rail 1 in such a manner as to extend in the axial direction, i.e., four rolling-element rolling grooves 3 are formed in total. In a slider body 2A of the slider 2, rolling-element rolling grooves 5 are formed in inner side surfaces of its both sleeve potions 4 in such a manner as to respectively oppose the rolling-element rolling grooves 3. A multiplicity of rollers 6 serving as rolling elements are rollably loaded between the rolling-element rolling grooves 3 and 5. The arrangement provided is such that the slider 2 is capable of relatively moving on the guide rail 1 along the axial direction as these rollers 6 roll.

In conjunction with this movement, the rollers 6 interposed between the guide rail 1 and the slider 2 roll and move to an axial end of the slider 2. To allow the slider 2 to move continuously in the axial direction, it is necessary to endlessly circulate these rollers 6.

For this reason, two upper and lower (a total of four on both sides) holes 7 are formed in the sleeve portion 4 on either side of the slider body 2A in such a manner as to axially penetrate therein. A circulating tube 8 whose interior is formed as a passage (rolling element passage) 8a of the rollers 6 is fitted in the hole 7. In addition, a pair of end caps 9 serving as rolling element circulating parts are respectively fixed to both axial ends of the slider body 2A by means of screws or the like. A direction changing passage (not shown), which is curved in the shape of a semi-circular arc, is formed in each of these end caps 9 to allow the rolling element passage 8a to communicate with both of the rolling-element rolling grooves 3 and 5. An endlessly circulating track is formed for the rollers 6 by the rolling-element rolling grooves 3 and 5, the rolling element passages 8a, and the direction changing passages.

It should be noted that in the drawing reference numeral 20 denotes a separator which is interposed between mutually adjacent ones of the rollers 6 so as to make smooth the traveling of the slider 2 by preventing direct contact between the rollers and to reduce noise during traveling.

In addition, as a ball screw device, for example, a relatively large-sized ball screw device such as the one shown in FIG. 9 is known which is used in an electric injection molding machine or a press machine and to which a large load is applied.

This ball screw device is comprised of a threaded shaft 110 having a spirally shaped ball screw groove (rolling-element rolling groove) 110a on its outer peripheral surface; a nut 120 having a ball screw groove (rolling-element rolling groove) opposing the ball screw groove 110a of this threaded shaft 110; and a plurality of balls (rolling elements) disposed rollably in the ball rolling passage formed between the ball screw groove 110a of this threaded shaft 110 and the ball screw groove of the nut 120.

In addition, a return tube 130 for scooping up the balls which come rolling and for sending them to the other end is fixed to one end of this ball rolling passage by means of a tube holder 130a. This ball screw device is arranged such that as the threaded shaft 110 and the nut 120 are relatively rotated to move one of them in the axial direction, the threaded shaft 110 and the nut 120 are made to undergo relative screw motion through the rolling of the plurality of balls.

In the linear guide bearing device such as the above-described linear guide device and a cross roller guide device, a large load is frequently supported as compared with a rotating bearing such as a rolling bearing. Meanwhile, there is a characteristic that the rolling speed of the rolling elements is substantially slow as compared with the rotating bearing since the track length is finite and an inverting operation is required without fail. For this reason, there is a problem in that an oil film is difficult to be formed between the rolling element and the rolling-element rolling groove, so that the rolling elements and the rolling-element rolling grooves are likely to be worn and damaged.

In addition, the above-described ball screw device is used with a short stroke at which a high load is applied instantaneously, and is used under a severe condition of reciprocating motion in which it rotates reversely after stopping temporarily in the state in which a maximum load has been applied. For this reason, from the perspectives that the ball screw device should be able to receive as large a load as possible and that its required service life should be optimally satisfied, an attempt is made to make the groove radius ratios of the threaded shaft and the nut as close to the diameter of the rolling element as possible, so as to lower the surface pressure and satisfy the required service life.

In addition, the ball screw device has a characteristic that, because of its shape, the rolling speed of the rolling elements is slow as compared with an ordinary ball bearing or the like. For this reason, there is a problem in that an oil film is difficult to be formed between the rolling element and the rolling-element rolling groove, so that the rolling elements and the rolling-element rolling grooves are likely to be worn and damaged.

As methods for preventing wear and damage of a sliding potion of a metallic product and a rolling roller of a rotating bearing, there have been proposed a method in which oil reservoirs constituted by numerous infinitesimal recesses each having a substantially circular arc-shaped section are formed in the surface of a sliding portion of a metallic product (refer to, for example, Japanese Patent No. 3212433 (hereafter referred to as patent document 1)), and a method in which an irregular surface having a value of surface roughness RMS of 0.10 μm or more is formed on the surface of a rolling roller of a rotating bearing (refer to, for example, Japanese Patent No. 2758518 (hereafter referred to as patent document 2)).

However, the above-described patent documents 1 and 2 do not disclose or suggest a linear guide bearing device or a ball screw device in which an oil film is difficult to be formed between the rolling element and the rolling-element rolling groove, and the rolling elements and the rolling-element rolling grooves are likely to be worn and damaged, as described above.

In addition, with the linear guide bearing device and the ball screw device, the rolling-element rolling grooves are generally finished by form grinding in which the track surface shape is form ground as a form grinding wheel obtained by forming a grinding wheel in advance into a target cross-sectional shape is relatively moved in the axial direction while being rotated, to thereby transfer the grinding wheel shape.

For this reason, as compared with the axial surface roughness, the orthogonal surface roughness, to which the grinding wheel shape is transferred as it is, is bound to be fairly rough. Consequently, the situation is such that, as shown in FIG. 10, the surface shape becomes that of tire grooves, so that the oil film is likely to be broken. Accordingly, there is a problem in that even if oil reservoirs constituted by infinitesimal recesses are provided in the surface of the rolling-element rolling groove, it cannot be said that its effect is sufficient.

Meanwhile, as compared with an ordinary ball bearing or the like, the ball screw device has a large sliding component because of its shape. As a result, the tangential force within the contact ellipse is large, and coupled with the fact that the aforementioned groove radius ratios of the shaft and the nut are made small, the tangential force becomes large, and surface-initiated flaking and subsurface-initiated flaking due to white etching areas can occur, possibly resulting in early damage.

### SUMMARY OF THE INVENTION

An object of the present invention to provide a linear motion device which is capable of ensuring excellent lubricity and improving wear resistance.

To attain the above object, in accordance with a first aspect of the invention, there is provided a linear motion device for receiving a load through a plurality of rolling elements sandwiched between a first and a second rolling-element rolling groove, wherein oil reservoirs constituted by numerous infinitesimal recesses each having a substantially circular arc-shaped section and having a surface roughness of 0.02 to 0.2 μm Ra are formed in a surface of at least one of each of the rolling elements, the first rolling-element rolling groove, and the second rolling-element rolling groove.

In the invention according to a second aspect, in the linear motion device according to the first aspect, the oil reservoirs are formed by injecting onto the surface of the at least one of each of the rolling elements, the first rolling-element rolling groove, and the second rolling-element rolling groove substantially spherical shots of 20 to 200 μm having a hardness equivalent to or greater than the hardness of the surface at an injection rate of 50 m/sec. or greater.

In the invention according to a third aspect, in the linear motion device according to the second aspect, the shots with a lubricating substance such as molybdenum disulfide coated on surfaces thereof are injected onto the surface of the at least one of each of the rolling elements, the first rolling-element rolling groove, and the second rolling-element rolling groove, thereby allowing the lubricating substance to be transferred and attached to the surface of the at least one of each of the rolling elements, the first rolling-element rolling groove, and the second rolling-element rolling groove.

In the invention according to a fourth aspect, the linear motion device according to the first aspect is a linear guide bearing device.

In the invention according to a fifth aspect, the linear motion device according to the first aspect is a ball screw device.

### BRIEF DESCRIPTION OF THE DRAWINGS

FIG. 1 is a schematic diagram of oil reservoirs constituted by numerous infinitesimal recesses each having a substantially circular arc-shaped section and formed in the surface of a roller serving as a rolling element of a linear guide device in accordance with a first embodiment of the invention;

FIG. 2 is a graph illustrating the relationship between the roller surface roughness (μm Ra) and the amount of wear of the surface of a rolling-element rolling groove;

FIG. 3 is a schematic diagram of oil reservoirs constituted by numerous infinitesimal recesses each having a substantially circular arc-shaped section and formed in the surface of the rolling-element rolling groove of a linear guide device in accordance with a second embodiment of the invention;

FIG. 4 is a graph illustrating the comparison of the amount of wear of the rolling-element rolling groove in cases where the oil reservoirs were formed in the roller surface, the surfaces of both rolling-element rolling grooves, and the roller surface plus the surfaces of both rolling-element rolling grooves, respectively;

FIG. 5 is a schematic diagram of oil reservoirs constituted by numerous infinitesimal recesses each having a substantially circular arc-shaped section and formed in the ball surface or the ball screw groove surface of a ball screw device in accordance with a third embodiment of the invention;

FIG. 6 is a graph illustrating the relationship between the surface roughness (μm Ra) of each surface and the life ratio in cases where the oil reservoirs were formed in the ball surface, the ball rolling groove surface of a threaded shaft, and the ball rolling groove surface of a nut, respectively;

FIG. 7 is a graph illustrating the relationship between the surface-treated portion and the life ratio in cases where the oil reservoirs were formed in the ball surface, the ball rolling groove surface of the threaded shaft, and the ball rolling groove surface of the nut, respectively;

FIG. 8 is a diagram, partly in section, illustrating an example of the linear guide device;

FIG. 9 is a diagram illustrating an example of a ball screw for a relatively high load; and

FIG. 10 is a schematic diagram of the surface of a rolling-element rolling groove processed by form grinding in a related art.

### DESCRIPTION OF THE PREFERRED EMBODIMENTS

Referring now to the accompanying drawings, a description will be given of the embodiments of the invention.

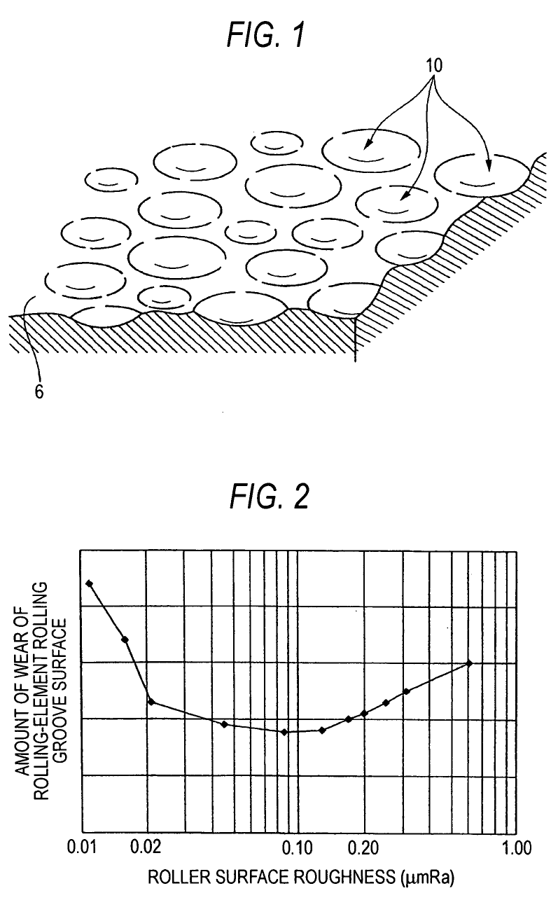

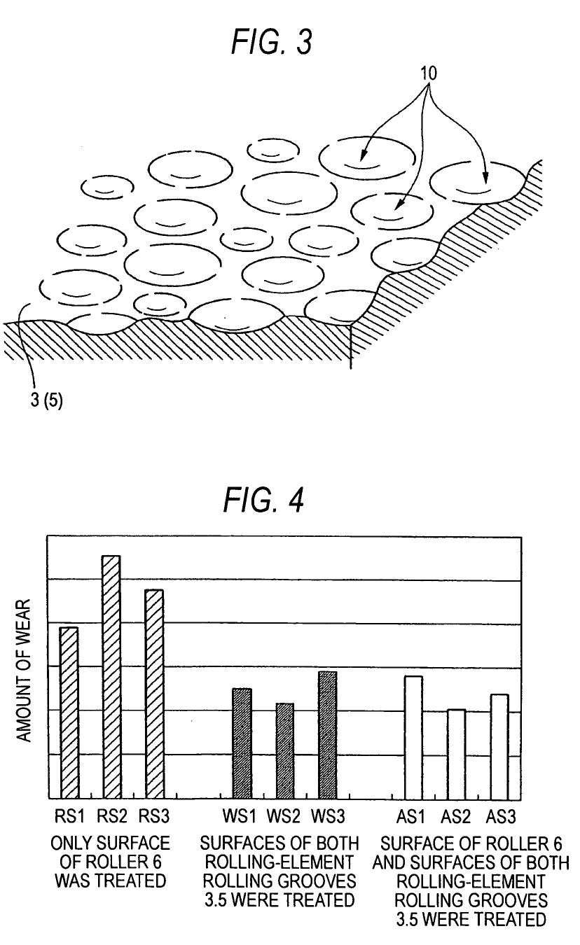

FIG. 1 is a schematic diagram of oil reservoirs constituted by numerous infinitesimal recesses each having a substantially circular arc-shaped section and formed in the surface of a roller serving as a rolling element of a linear guide device in accordance with a first embodiment of the invention. FIG. 2 is a graph illustrating the relationship between the roller surface roughness (μm Ra) and the amount of wear of the surface of a rolling-element rolling groove. FIG. 3 is a schematic diagram of oil reservoirs constituted by numerous infinitesimal recesses each having a substantially circular arc-shaped section and formed in the surface of the rolling-element rolling groove of a linear guide device in accordance with a second embodiment of the invention. FIG. 4 is a graph illustrating the comparison of the amount of wear of the rolling-element rolling groove in cases where the oil reservoirs were formed in the roller surface, the surfaces of both rolling-element rolling grooves, and the roller surface plus the surfaces of both rolling-element rolling grooves, respectively. It should be noted that a description will be given of the respective embodiments and only the differences with the linear guide device already described with reference to FIG. 8, and the same reference numerals will be used for those portions which overlap with FIG. 8.

In the linear guide device in accordance with a first embodiment of the invention, while oil reservoirs 10 constituted by numerous infinitesimal recesses each having a substantially circular arc-shaped section are formed in the surface of a roller 6, as shown in FIG. 1, the surface roughness of the roller 6 is kept to 0.02 to 0.2 μm Ra. As a result, the breaking of an oil film between the roller 6 and a rolling-element rolling groove 3 and the roller 6 and a rolling-element rolling groove 5 is prevented, and excellent lubricity is ensured, thereby making it possible to obtain the effect of reducing the wear of the roller 6 and the rolling-element rolling grooves 3 and 5.

FIG. 2 shows the relationship between the roller surface roughness (Ra value) and the amount of wear of the surface of the rolling-element rolling groove in a case where the oil reservoirs 10 were formed in the surface of the roller.

As is apparent from FIG. 2, it is be seen that the wear reduction effect becomes large by setting the surface roughness Ra value of the roller to 0.02 to 0.2 μm Ra.

In addition, to form the oil reservoirs 10 in the surface of the roller 6, an economical and simple method is to inject onto the surface of the roller 6 substantially spherical shots of 20 to 200 μm having a hardness equivalent to or greater than the hardness of the roller surface at an injection rate of 50 m/sec. or greater. In this method, the effect as a wear reduction measure can be increased since not only can the shape of the roller surface be improved, but this process can also serve as the heat treatment of the surface layer for recrystallizing and hardening the metallographic structure as the surface temperature is raised to the A3 transformation point or higher of the steel product during the treatment.

Furthermore, in preparation for the contact between the metal surfaces in the event that the oil film is broken, the shots coated with a lubricating substance such as molybdenum disulfide on their surfaces are injected onto the surface of the roller 6. The lubricating substance can thereby be imprinted into the surface of the roller 6 with a depth of several microns or thereabouts from the surface through solid diffusion (the lubricating substance is likely to solidly diffuse since the surface temperature becomes high). By so doing, even if the surface layer of the roller 6 is worn to some extent, the wear resistance can be maintained over long periods of time without losing the effect of this imprinted lubricating substance.

Referring next to FIGS. 3 and 4, a description will be given of the linear guide device in accordance with a second embodiment of the invention.

In the linear guide device in accordance with the second embodiment of the invention, while the oil reservoirs 10 constituted by numerous infinitesimal recesses each having a substantially circular arc-shaped section are formed in the surfaces of the rolling-element rolling grooves 3 and 5, as shown in FIG. 3, the surface roughness of the rolling-element rolling grooves 3 and 5 is kept to 0.2 to 0.2 μm Ra. As a result, the breaking of an oil film between the roller 6 and a rolling-element rolling groove 3 and the roller 6 and a rolling-element rolling groove 5 is prevented, and excellent lubricity is ensured, thereby making it possible to obtain the effect of reducing the wear of the roller 6 and the rolling-element rolling grooves 3 and 5.

In addition, to form the oil reservoirs 10 in the surfaces of the rolling-element rolling grooves 3 and 5, an economical and simple method is to inject onto the surfaces of the rolling-element rolling grooves 3 and 5 substantially spherical shots of 20 to 200 μm having a hardness equivalent to or greater than the hardness of the surfaces of the rolling-element rolling grooves 3 and 5 at an injection rate of 50 m/sec. or greater. In this method, the effect as a wear reduction measure can be increased since not only can the shapes of the surfaces of the rolling-element rolling grooves 3 and 5 be improved, but this process can also serve as the heat treatment of the surface layer for recrystallizing and hardening the metallographic structure as the surface temperature is raised to the A3 transformation point or higher of the steel product during the treatment.

Such improvement of the surface conditions of the rolling-element rolling grooves 3 and 5 produces a remarkable effect on improving the wear resistance of the linear guide bearing device having the circumstances in which, as described above, since the surface shape has an effect similar to that of tire grooves owing to form grinding, the oil film is likely to be broken, and since a large load must be supported at a low speed as compared with a rotating bearing, the oil film is additionally difficult to be formed.

FIG. 4 shows the results of comparison of the amount of wear of the rolling-element rolling groove between cases (RS1, RS2, and RS3) where the oil reservoirs 10 were formed only in the surface of the roller 6 and cases (WS1, WS2, and WS3) where the oil reservoirs 10 were formed in the surfaces of both rolling-element rolling grooves 3 and 5.

As is apparent from FIG. 4, it can be seen that the amount of wear halved in the cases where the oil reservoirs 10 were formed in the surfaces of both rolling-element rolling grooves 3 and 5 as compared with the cases where the oil reservoirs 10 were formed only in the surface of the roller 6. It should be noted that cases (RS1, RS2, and RS3) were naturally conceivable where the oil reservoirs 10 were formed in the surface of the roller 6 and the surfaces of both rolling-element rolling grooves 3 and 5, respectively. In that case, however, the wear reduction effect remained practically unchanged from the effect of the cases where the oil reservoirs 10 were formed only in the surfaces of both rolling-element rolling grooves 3 and 5. Therefore, in consideration of the treatment cost, it is judged that there is not much advantage in forming the oil reservoirs 10 in the surface of the roller 6 and the surfaces of both rolling-element rolling grooves 3 and 5, respectively.

Furthermore, in preparation for the contact between the metal surfaces in the event that the oil film is broken, the shots coated with a lubricating substance such as molybdenum disulfide on their surfaces are injected onto the surfaces of both rolling-element rolling grooves 3 and 5. The lubricating substance can thereby be imprinted into the surfaces of both rolling-element rolling grooves 3 and 5 with a depth of several microns or thereabouts from the surface through solid diffusion (the lubricating substance is likely to solidly diffuse since the surface temperature becomes high). By so doing, even if the surface layers of rolling-element rolling grooves 3 and 5 are worn to some extent, the wear resistance can be maintained over long periods of time without losing the effect of this imprinted lubricating substance.

It should be noted that the linear guide bearing device of the invention is not limited to the above-described first and second embodiments, and modifications may be made, as required, within the scope that does not depart from the gist of the invention.

For example, although in the above-described first and second embodiments the case in which the invention is applied to the linear guide device is adopted by way of example, the invention may alternatively be applied to a rolling element or a rolling-element rolling groove of a cross roller guide device.

In addition, although in the above-described first and second embodiments the roller is adopted as the rolling element by way of example, the invention is not limited to the same, the invention may be applied to a linear guide bearing device using balls as the rolling elements.

Furthermore, although in the above-described second embodiment the case in which the oil reservoirs 10 are formed in the surfaces of both rolling-element rolling grooves 3 and 5, respectively, the invention is not limited to the same, and the oil reservoirs 10 may be formed in the surface of one of the rolling-element rolling grooves 3 and 5.

Next, a description will be given of a ball screw device in accordance with a third embodiment of the invention.

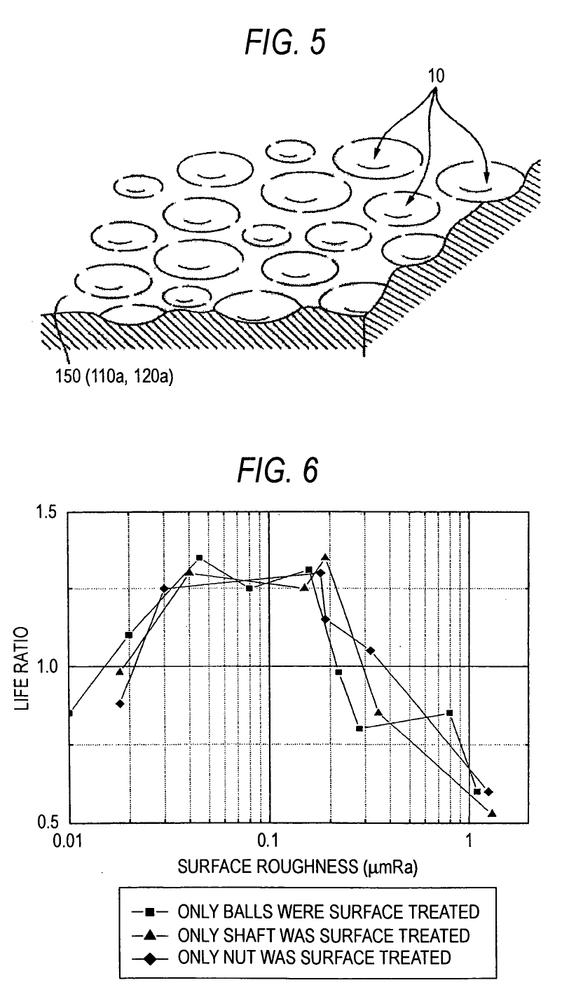

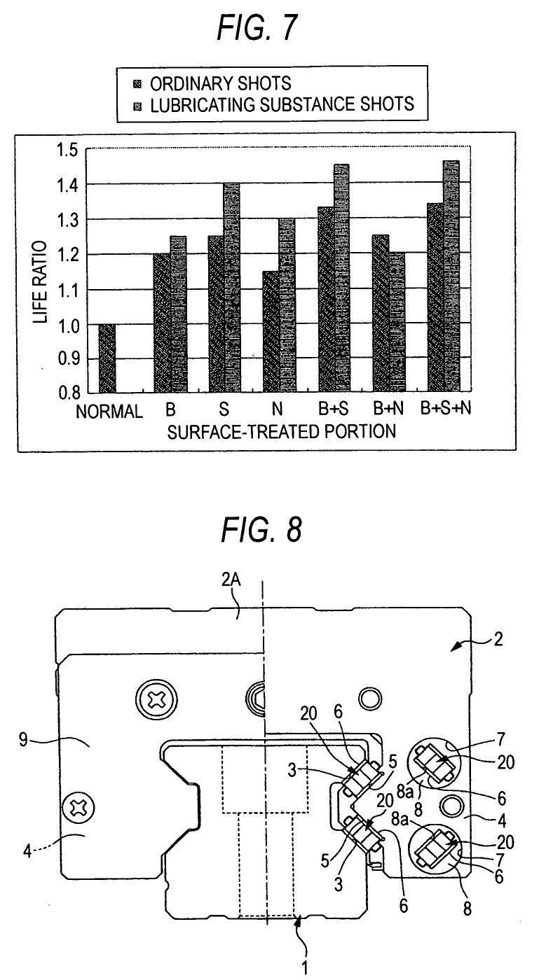

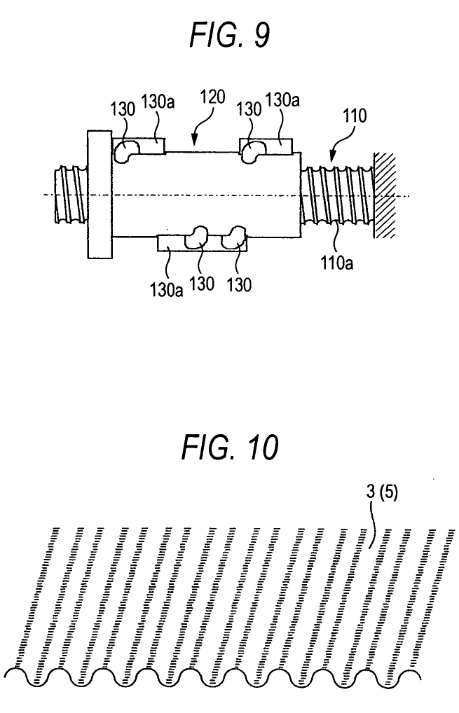

FIG. 5 is a schematic diagram of oil reservoirs constituted by numerous infinitesimal recesses each having a substantially circular arc-shaped section and formed in the ball surface or the ball screw groove surface of a ball screw device in accordance with a third embodiment of the invention. FIG. 6 is a graph illustrating the relationship between the surface roughness (μm Ra) of each surface and the life ratio in cases where the oil reservoirs were formed in the ball surface, the ball rolling groove surface of a threaded shaft, and the ball rolling groove surface of a nut, respectively. FIG. 7 is a graph illustrating the relationship between the surface-treated portion and the life ratio in cases where the oil reservoirs were formed in the ball surface, the ball rolling groove surface of the threaded shaft, and the ball rolling groove surface of the nut, respectively. It should be noted that a description will be given of the respective embodiments and only the differences with the ball screw device already described with reference to FIG. 9, and the same reference numerals will be used for those portions which overlap with FIG. 9.

In the ball screw device in accordance with the third embodiment of the invention, while oil reservoirs 100 constituted by numerous infinitesimal recesses each having a substantially circular arc-shaped section are formed in the surface of at least one of each ball 150, a ball screw groove 110a of a threaded shaft 110, and a ball screw groove 120a of a nut 120, as shown in FIG. 5, the surface roughness of each of the balls 150 is kept to 0.02 to 0.2 μm Ra. As a result, the breaking of the oil film between the ball 150 and the ball screw groove 110a of the threaded shaft 110 and between the ball 150 and the ball screw groove 120a of the nut 120 is prevented, and excellent lubricity is ensured, thereby making it possible to obtain the effect of reducing the wear of the ball 150, the ball screw groove 110a of the threaded shaft 110, and the ball screw groove 120a of the nut 120.

FIG. 6 shows the relationship between the surface roughness (Ra value) and the life ratio in cases where the oil reservoirs were formed in the surfaces of the balls 150, the ball screw groove 110a of the threaded shaft 110, and the ball screw groove 120a of the nut 120. Here, the ball screw device and the test conditions used in a durability test were as follows.

NSK-made ball screw device: BS6316-10.5

Shaft diameter: 65 mm

Lead: 16 mm

BCD: 65 mm

Ball diameter: 12.7 mm

Effective turns of balls: 3.5 turns×3 rows

Lubrication: YS2 grease made by LUBE Corporation was automatically supplied by an automatic lubricator.

As for the durability test, the traveling distance until flaking occurred in any one of the balls and the ball screw grooves was confirmed by a ball screw durability testing machine made by NSK Ltd., and it was determined that the life of the ball screw arrived when the flaking occurred.

As is apparent from FIG. 6, it can be seen that an outstanding life characteristic was shown as the surface roughness of the balls, the ball screw groove of the threaded shaft, and the ball screw groove of the nut was kept to 0.02 to 0.2 μm Ra.

In addition, such improvement of the surface conditions of the ball screw grooves of the threaded shaft and the nut produces a remarkable effect on improving the wear resistance of the ball screw device having the circumstances in which, as described above, since the surface shape has an effect similar to that of tire grooves owing to form grinding, the oil film is likely to be broken, and since a large load must be supported at a low speed as compared with a rotating bearing, the oil film is additionally difficult to be formed.

In addition, to form the oil reservoirs 110 in the surfaces of the balls and the ball screw grooves, an economical and simple method is to inject onto the surfaces of the balls and the ball screw grooves substantially spherical shots of 20 to 200 μm having a hardness equivalent to or greater than the hardness of the surfaces of the balls and the ball screw grooves at an injection rate of 50 m/sec. or greater (hereafter, these shots will be referred to as the ordinary shots). In this method, the effect as a wear reduction measure can be increased since not only can the shapes of the surfaces of the balls and the ball screw grooves be improved, but this process can also serve as the heat treatment of the surface layer for recrystallizing and hardening the metallographic structure as the surface temperature is raised to the A3 transformation point or higher of the steel product during the treatment.

Furthermore, in preparation for the contact between the metal surfaces in the event that the oil film is broken, the shots coated with a lubricating substance such as molybdenum disulfide on their surfaces are injected onto the surfaces of the balls and the ball screw grooves (hereafter, these shots will be referred to as the lubricating shots). The lubricating substance can thereby be imprinted into the surfaces of the balls and the ball screw grooves with a depth of several microns or thereabouts from the surface through solid diffusion (the lubricating substance is likely to solidly diffuse since the surface temperature becomes high). By so doing, even if the surface layers of the balls and the ball screw grooves are worn to some extent, the wear resistance can be maintained over long periods of time without losing the effect of this imprinted lubricating substance.

FIG. 7 shows the relationship between the surface-treated portion and the life ratio in cases where the ordinary shots and the lubricating shots were respectively provided for the balls, the ball screw groove of the threaded shaft, and the ball screw groove of the nut. It should be noted that the ball screw device and the test conditions used in the durability test were the same as those for FIG. 6.

In the abscissa of FIG. 7, Normal indicates a ball screw device for a high load application not provided with surface treatment (oil reservoirs were not formed); B, a ball screw device provided with surface treatment on ball surfaces; S, a ball screw device provided with surface treatment on the ball screw groove of the threaded shaft; N, a ball screw device provided with surface treatment on the ball screw groove of the nut; B+S, a ball screw device provided with surface treatment on ball surfaces plus surface treatment on the ball screw groove of the threaded shaft; B+N, a ball screw device provided with surface treatment on ball surfaces plus surface treatment on the ball screw groove of the nut; and B+S+N, a ball screw device provided with surface treatment on ball surfaces plus surface treatment on the ball screw groove of the threaded shaft plus surface treatment on the ball screw groove of the nut. In addition, as for the life ratio on the ordinate, the life of the ball screw device (Normal) not provided with surface treatment is assumed to be 1.

As is apparent from FIG. 7, it can be seen that the life improves by 1.15 times to 1.5 times or thereabouts in the case where the ordinary shots are provided as compared with the ball screw device (Normal) in which the oil reservoirs are not formed. Further, it can be seen that the life improves by 1.2 times to 1.5 times or thereabouts in the case where the lubricating shots are provided as compared with the ball screw device (Normal) in which the oil reservoirs are not formed.

In addition, as shown in FIG. 7, it can be seen that the life improves substantially in the case where the ordinary shots or lubricating shots are provided for the balls and the ball screw groove of the threaded shaft, the balls and the ball screw groove of the threaded shaft and/or the ball screw groove of the nut in combination as compared with the case where the ordinary shots or lubricating shots are provided for any one of the balls, the ball screw groove of the threaded shaft, and the ball screw groove of the nut.

It should be noted that the ball screw device of the invention is not limited to the above-described third embodiment, and modifications may be made, as required, within the scope that does not depart from the gist of the invention.

As is apparent from the foregoing description, in accordance with the first aspect of the invention, while oil reservoirs constituted by numerous infinitesimal recesses each having a substantially circular arc-shaped section are formed in the surface of at least one of each rolling element, the first rolling-element rolling groove, and the second rolling-element rolling groove, the surface roughness of the surface where the oil reservoirs are formed is kept to 0.02 to 0.2 μm Ra. Therefore, excellent lubricity can be ensured by preventing the breaking of the oil film between the rolling element and the rolling-element rolling groove, thereby making it possible to obtain the effect of reducing the wear of the rolling elements and the rolling-element rolling grooves. In addition, early damage to the linear motion device due to faulty lubrication does not occur, thereby making it possible to obtain the effect of a prolonged life.

In the invention according to the second aspect, in addition to the invention according to the first aspect, the oil reservoirs can be formed in the surface of the at least one of each rolling element, the first rolling-element rolling groove, and the second rolling-element rolling groove by an economical and simple method. In addition, not only can the shapes of the surfaces of the rolling elements, the first rolling-element rolling groove and/or the second rolling-element rolling groove be improved, but the process of forming the oil reservoirs can also serve as the heat treatment of the surface layer for recrystallizing and hardening the metallographic structure as the surface temperature is raised to the A3 transformation point or higher of the steel product during the treatment. Accordingly, the effect as a wear reduction measure can be increased. Further, it is possible to obtain the effect on the improvement of flaking resistance, thereby making it possible to obtain the effect of a prolonged life.

In the invention according to the third aspect, in addition to the invention according to the second aspect, even if the surface layer with the lubricating substance transferred and attached thereto is worn to some extent, the effect of the lubricating substance transferred and attached to the surface of the at least one of each rolling element, the first rolling-element rolling groove, and the second rolling-element rolling groove is not lost. Accordingly, it is possible to maintain the wear resistance of the rolling elements and the rolling-element rolling grooves over long periods of time. In addition, it is possible to maintain lubricity, thereby making it possible to obtain the effect of a prolonged life.

In the invention according to the fourth aspect, in the linear guide bearing device, while oil reservoirs constituted by numerous infinitesimal recesses each having a substantially circular arc-shaped section are formed in the surface of the at least one of each rolling element, the first rolling-element rolling groove, and the second rolling-element rolling groove, the surface roughness of the surface where the oil reservoirs are formed is kept to 0.02 to 0.2 μm Ra. Therefore, excellent lubricity can be ensured by preventing the breaking of the oil film between the rolling element and the rolling-element rolling groove, thereby making it possible to obtain the effect of reducing the wear of the rolling elements and the rolling-element rolling grooves. In addition, early damage to the linear guide bearing device due to faulty lubrication does not occur, thereby making it possible to attain a prolonged life.

In the invention according to the fifth aspect, in the ball screw device, while oil reservoirs constituted by numerous infinitesimal recesses each having a substantially circular arc-shaped section are formed in the surface of the at least one of each rolling element, the rolling-element rolling groove of a threaded shaft, and the rolling-element rolling groove of a nut, the surface roughness of the surface where the oil reservoirs are formed is kept to 0.02 to 0.2 μm Ra. Therefore, excellent lubricity can be ensured by preventing the breaking of the oil film between the rolling element and the rolling-element rolling groove, thereby making it possible to obtain the effect of reducing the wear of the rolling elements and the rolling-element rolling grooves. In addition, early damage to the ball screw device due to faulty lubrication does not occur, thereby making it possible to attain a prolonged life.

1. A linear motion device for receiving a load through a plurality of rolling elements sandwiched between a first and a second rolling-element rolling groove, wherein oil reservoirs constituted by numerous infinitesimal recesses each having a substantially circular arc-shaped section and having a surface roughness of 0.02 to 0.2 μm Ra are formed in a surface of at least one of each of the rolling elements, the first rolling-element rolling groove, and the second rolling-element rolling groove.

2. The linear motion device according to claim 1, wherein the oil reservoirs are formed by injecting onto the surface of the at least one of each of the rolling elements, the first rolling-element rolling groove, and the second rolling-element rolling groove substantially spherical shots of 20 to 200 μm having a hardness equivalent to or greater than the hardness of the surface at an injection rate of 50 m/sec. or greater.

3. The linear motion device according to claim 2, wherein the shots with a lubricating substance coated on surfaces thereof are injected onto the surface of the at least one of each of the rolling elements, the first rolling-element rolling groove, and the second rolling-element rolling groove, thereby allowing the lubricating substance to be transferred and attached to the surface of the at least one of each of the rolling elements, the first rolling-element rolling groove, and the second rolling-element rolling groove.

4. The linear motion device according to claim 1, wherein the linear motion device is a linear guide bearing device.

5. The linear motion device according to claim 1, wherein the linear motion device is a ball screw device.
